(19) United States
(12) Patent Application Publication
(10) Pub. No.: US 2020/0125607 A1
(43) Pub. Date: Apr. 23, 2020

(54) SYSTEM AND METHOD FOR ANALYSIS OF WEB ANALYTICS TAGS

(71) Applicant: Nabler Web Solutions Pvt. Ltd., Bangalore (IN)

(72) Inventors: Sreenath Maikkara, BANGALORE (IN); Stephen Raj D, VELLORE (IN); Samiksha Jain, Bangalore (IN)

(21) Appl. No.: 16/250,730

(22) Filed: Jan. 17, 2019

(30) Foreign Application Priority Data
Oct. 18, 2018 (IN) 201841039556

(51) Int. Cl. G06F 16/951; G06F 16/958; G06F 17/22; H04L 29/08

(52) U.S. Cl. CPC G06F 16/951; G06F 16/958; H04L 67/02; G06F 17/2247; G06F 17/227

(57) ABSTRACT

A system for analysis of a plurality of web analytics tags is disclosed. The system includes a proxy subsystem configured to receive a request from a web page requestor subsystem to fetch the plurality of web analytics tags of a webpage. The system also includes an analysis subsystem configured to analyse the plurality of web analytics tags based on a set of custom rules. The set of custom rules includes a first rule to analyse a type of object requested by the web page requestor subsystem, a second rule to analyse a response type for the type of the object requested and a third rule to analyse a part of the request with the response type of the object corresponding to the request received from the web page requestor subsystem. The system further includes a validation subsystem configured to validate successful execution of the plurality of web analytics tags.

### CROSS-REFERENCE TO RELATED APPLICATION

This application claims the benefit of complete patent application having Patent Application No. 201841039556 filed on Oct. 18, 2018 in India.

### BACKGROUND

Embodiments of a present disclosure relate to a web analytics system and more particularly to a system and a method for analysis of web analytics tags.

Web analytics is the process of analysing the behaviour of visitors to a website. The use of web analytics is to enable a business to attract more visitors, retain or attract new customers for goods or services, or to increase the money each customer spends. The web analytics provides information about a plurality of visitors to a website and number of page views, which may help to estimate network traffic and popularity trends which is helpful in market research. The web analytics is divided into two categories such as off-site and on-site web analytics. The off-site web analytics deals with measurement of a website's potential audience or opportunity, visibility, and comments on the website as a whole. On the other hand, the on-site web analytics measures performance of the website in a commercial context by monitoring behavior of the plurality of visitors on the website. The monitoring of the plurality of visitors is done by analyzing the network traffic, plurality of web analytics tags embedded in the webpages by using one or more techniques. Various approaches are available which analyzes the plurality of web analytics tags in order to measure the web analytics.

Conventionally, the approaches which analyses the plurality of web analytics tags by gathering information of the plurality of visitor's data by tracking source code of the webpages or by manually tracking the web site without using any analytic elemental rules for the plurality of web analytics tags and analysing the log files. However, manually tracking the source code of the webpages or analysing the source code without any association of the plurality of web analytics tags with the source code becomes cumbersome and time consuming. Also, such approaches due to imperfect analysis may sometimes leads to data loss and causes incorrect judgement of commercial value of the webpage.

Hence, there is a need for an improved system and method for analysis of web analytics tags in order to address the aforementioned issues.

### BRIEF DESCRIPTION

In accordance with an embodiment of the present disclosure, a system for analysis of a plurality of web analytics tags is provided. The system includes a proxy subsystem configured to receive a request from a web page requestor subsystem to fetch the plurality of web analytics tags of at least one webpage of a website. The system also includes an analysis subsystem operatively coupled to the proxy subsystem. The analysis subsystem is configured to analyse the plurality of web analytics tags based on a set of custom rules. The set of custom rules includes a first rule configured to analyse a type of object being requested by the web page requestor subsystem. The set of custom rules also includes a second rule configured to analyse a response type for the type of the object being requested. The set of custom rules further includes a third rule configured to analyse a part of the request with the response type of the object corresponding to the request received from the web page requestor subsystem. The system further includes a validation subsystem operatively coupled to the analysis subsystem. The analysis subsystem is configured to validate successful execution of the plurality of web analytics tags.

In accordance with another embodiment of the present disclosure, a method for analysis of a plurality of web analytics tags is provided. The method includes receiving, by a proxy subsystem, a request from a web page requestor subsystem to fetch the plurality of web analytics tags of at least one webpage of a website. The method also includes analysing, by an analysis subsystem, the plurality of web analytics tags based on a set of custom rules. The analysis of the plurality of web analytics tags based on the set of custom rules includes analysing, by a first rule, a type of object being requested by the web page requestor subsystem. The analysis of the plurality of web analytics tags based on the set of custom rules also includes analysing, by a second rule, a response type for the type of the object being requested. The analysis of the plurality of web analytics tags based on the set of custom rules further includes analysing, by a third rule, a part of the request with the response type of the object corresponding to the request received from the web page requestor subsystem. the method further includes validating, by a validation subsystem, successful execution of the plurality of web analytics tags.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram of a system for analysis of web analytics tags in accordance with an embodiment of the present disclosure;

FIG. 2 is a schematic representation of an exemplary system for analysis of the web analytics tags of FIG. 1 in accordance with an embodiment of the present disclosure; and

FIG. 3 is a flow chart representing the steps involved in a method for analysis of the web analytics tags of FIG. 1 in accordance with the embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system for analysis of a plurality of web analytics tags. The system includes a proxy subsystem configured to receive a request from a web page requestor subsystem to fetch the plurality of web analytics tags of at least one webpage of a website. The system also includes an analysis subsystem operatively coupled to the proxy subsystem. The analysis subsystem is configured to analyse the plurality of web analytics tags based on a set of custom rules. The set of custom rules includes a first rule configured to analyse a type of object being requested by the web page requestor subsystem. The set of custom rules also includes a second rule configured to analyse a response type for the type of the object being requested. The set of custom rules further includes a third rule configured to analyse a part of the request with the response type of the object corresponding to the request received from the web page requestor subsystem. The system further includes a validation subsystem operatively coupled to the analysis subsystem. The analysis subsystem is configured to validate successful execution of the plurality of web analytics tags.

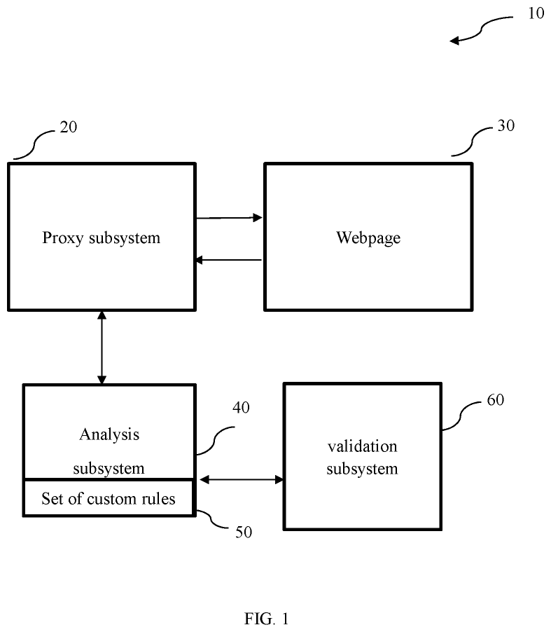

FIG. 1 is a block diagram representation of a system (10) for analysis of a plurality of web analytics tags in accordance with an embodiment of the present disclosure. The system (10) includes a proxy subsystem (20) configured to receive a request from a web page requestor subsystem to fetch the plurality of web analytics tags of at least one webpage (30) of a web site. In one embodiment, the at least one webpage (30) may include a hypertext mark-up language (HTML) page. In some embodiments, the web page requestor subsystem may include a headless web browser or a web crawler. As used herein, the term “headless web browser” is defined as a web browser without a graphical user interface (GUI). Instead of a GUI, the headless web browser accesses webpage but does not show them to any human being. Similarly, the term “web crawler” is defined as is an Internet assistant that systematically browses the World Wide Web, typically for the purpose of web indexing.

In a preferred embodiment, the at least one request may include a request for communication between a web browser and a server using a hypertext transfer protocol (HTTP). In a specific embodiment, the plurality of web analytics tags may include a JavaScript code. In such embodiment, the JavaScript code may include a text format.

In one embodiment, the proxy subsystem (20) may be configured to receive the response type of the object being requested and discards the response type of the object to reach the web page requestor subsystem. In a specific embodiment, the proxy subsystem (20) may be configured to capture one or more errors, one or more tag execution events and track the at least one webpage (30).

Furthermore, the system (10) includes an analysis subsystem (40) which is operatively coupled to the proxy subsystem (30). The analysis subsystem (40) is configured to analyse the plurality of web analytics tags based on a set of custom rules (50). The set of custom rules (50) includes a first rule which is configured to analyse a type of object being requested by the web page requestor subsystem. In one embodiment, the type of object being requested may include a JavaScript, a hypertext transfer mark-up language (HTML), a cascaded style sheet (CSS) or an image.

Moreover, the set of custom rules (50) also includes a second rule which is configured to analyse a response type for the type of the object being requested. In some embodiments, the response type of the object being requested may include a hypertext transfer protocol (HTTP) response 200, a hypertext transfer protocol (HTTP) response 404, or a hypertext transfer protocol (HTTP) response 400. The hypertext transfer protocol (HTTP) response 200 is corresponding to a success status, the hypertext transfer protocol (HTTP) response 404 is corresponding to an error message showing not found status, and the hypertext transfer protocol (HTTP) response 400 is corresponding to a bad request error.

In addition, the set of custom rules (50) further includes a third rule configured to analyse a part of the request with the response type of the object corresponding to the request received from the web page requestor subsystem. Further, the system (10) includes a validation subsystem (60) operatively coupled to the analysis subsystem (60). The validation subsystem (60) is configured to validate successful execution of the plurality of web analytics tags.

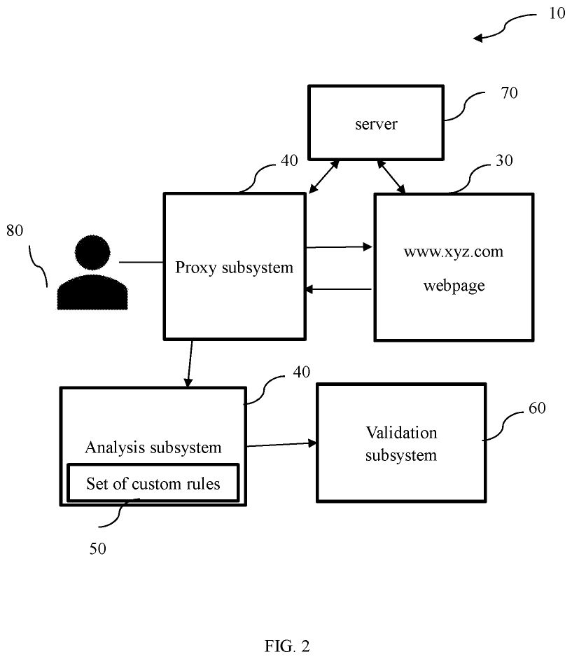

FIG. 2 is a block diagram of an exemplary system (10) for analysis of a plurality of web analytics tags of FIG. 1 in accordance with an embodiment of the present disclosure. Considering all the resources and events which requests a resource after the at least one webpage (30) render passes through the proxy subsystem (20). The proxy subsystem (20) analyses each request and response and run the request. The response through a set of custom rules (50) which verify the request and response by verifying the pattern of each request and response using the analysis subsystem.

In an example, the website www.xyz.com includes a plurality of web analytics tags. A client renders the webpage of www.xyz.com which contains the plurality of web analytics tags, and during the page render, the analysis subsystem (40) executes an analytics script which in turn makes a GET request to a server (70).

The analysis subsystem (40) captures the request and runs the request through the set of custom rules (50) which checks for patterns. For example, consider the rule which checks for any GET call to the server (70), which in this case is true and makes the rule execution status as success. Such analysis of rule happens parallelly while the original request is sent to the server (70)

The server (70) receives the request from the web analytics tag and assuming the capture at the server (70) end is successful and implementation of tag at a client (80) end is correct then the server (70) returns the response as success back to the proxy subsystem (20).

The proxy subsystem (20) receives the response as success from the server (70). The analysis subsystem (40) compares the rule which we assume as analytics response success, and by combining with the rule for GET request is success. The validation subsystem (60) verifies the status of rule, if the rule is successful which means tag validation is successful and web analytics health of the webpage is good. If any rule from the set of custom rules (30) fails, the validation subsystem (60) declares the unsuccessful validation of the plurality of web analytics tags.

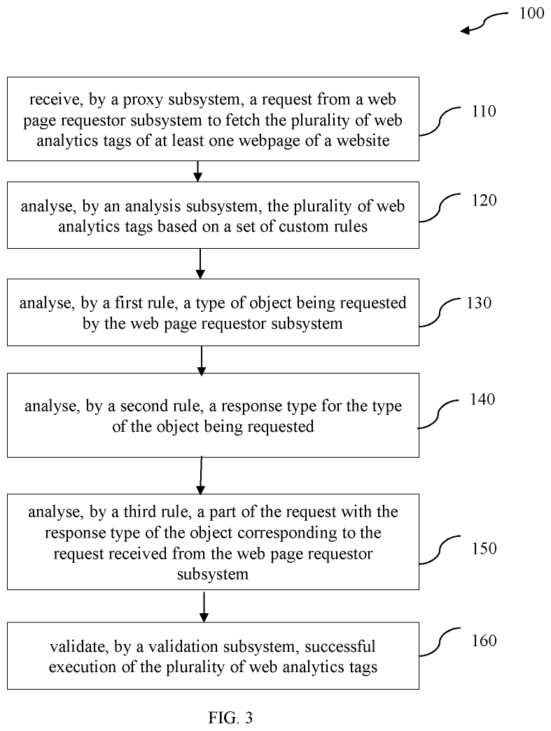

FIG. 3 is a flow chart representing the steps involved in a method (100) for analysis of a plurality of web analytics tags of FIG. 1 in accordance with an embodiment of the present disclosure. The method (100) includes receiving, by a proxy subsystem, a request from a web page requestor subsystem to fetch the plurality of web analytics tags of at least one webpage of a website in step 110. In one embodiment, receiving a request from a web page requestor subsystem to fetch the plurality of web analytics tags of at least one webpage of a website may include receiving the request from a headless web browser or a web crawler.

The method (100) also includes analysing, by an analysis subsystem, the plurality of web analytics tags based on a set of custom rules in step 120. The analysis of the plurality of web analytics tags based on the set of custom rules includes analysing, by a first rule, a type of object being requested by the web page requestor subsystem in step 130. In some embodiments, analysing, by the first rule, the type of object being requested by the web page requestor subsystem may include analysing, by the first rule, a JavaScript, a hypertext transfer mark-up language (HTML), a cascaded style sheet (CSS) or an image by the web page requestor subsystem.

The method (100) further includes analysing, by a second rule, a response type for the type of the object being requested in step 140. In a specific embodiment, analysing, by the second rule, the response type for the type of the object being requested may include analysing, by the second rule, a hypertext transfer protocol (HTTP) response 200, a hypertext transfer protocol (HTTP) response 404, or a hypertext transfer protocol (HTTP) response 400, wherein the hypertext transfer protocol (HTTP) response 200 is corresponding to a success status, the hypertext transfer protocol (HTTP) response 404 is corresponding to an error message showing not found status, and the hypertext transfer protocol (HTTP) response 400 is corresponding to a bad request error.

Furthermore, the method (100) includes the method (100) includes analysing, by a third rule, a part of the request with the response type of the object corresponding to the request received from the web page requestor subsystem in step 150. The method (100) further includes validating, by a validation subsystem, successful execution of the plurality of web analytics tags in step 160. In one embodiment, the method may include receiving the response type of the object being requested and discards the response type of the object to reach the web page requestor subsystem. In a preferred embodiment, the method may include capturing one or more errors, one or more tag execution events and tracks one or more webpages.

Various embodiments of the system for analysis of a plurality of web analytics tags described above enables valuable judgement of commercial value of the webpage. The system is very easy to install and may be applied to any website. The system may provide customised data collection and reporting, adding further time-saving advantages for businesses as the system performs the analysis based on the customized rules.

It will be understood by those skilled in the art that the foregoing general description and the following detailed description are exemplary and explanatory of the disclosure and are not intended to be restrictive thereof

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, the order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system (10) for measuring for analysis of a plurality of web analytics tags comprising:
a proxy subsystem (20) configured to receive a request from a web page requestor subsystem to fetch the plurality of web analytics tags of at least one webpage (30) of a website;
an analysis subsystem (40) operatively coupled to the proxy subsystem (20) and configured to analyse the plurality of web analytics tags based on a set of custom rules (50), wherein the set of custom rules (50) comprises:
a first rule configured to analyse a type of object being requested by the web page requestor subsystem;
a second rule configured to analyse a response type for the type of the object being requested;
a third rule configured to analyse a part of the request with the response type of the object corresponding to the request received from the web page requestor subsystem; and
a validation subsystem (60) operatively coupled to the analysis subsystem (40) and configured to validate successful execution of the plurality of web analytics tags.

2. The system (10) as claimed in claim 1, wherein the at least one webpage (30) comprises a hypertext mark-up language (HTML) page.

3. The system (10) as claimed in claim 1, wherein the web page requestor subsystem comprises a headless web browser or a web crawler.

4. The system (10) as claimed in claim 1, wherein the at least one request comprises a request for communication between a web browser and a server using a hypertext transfer protocol (HTTP).

5. The system (10) as claimed in claim 1, wherein the plurality of web analytics tags comprises a JavaScript code, wherein the JavaScript code comprises a text format.

6. The system (10) as claimed in claim 1, wherein the type of object being requested comprises a JavaScript, a hypertext transfer mark-up language (HTML), a cascaded style sheet (CSS) or an image.

7. The system (10) as claimed in claim 1, wherein the response type of the object being requested comprises a hypertext transfer protocol (HTTP) response 200, a hypertext transfer protocol (HTTP) response 404, or a hypertext transfer protocol (HTTP) response 400, wherein the hypertext transfer protocol (HTTP) response 200 is corresponding to a success status, the hypertext transfer protocol (HTTP) response 404 is corresponding to an error message showing not found status, and the hypertext transfer protocol (HTTP) response 400 is corresponding to a bad request error.

8. The system (10) as claimed in claim 1, wherein the proxy subsystem (20) is configured to receive the response type of the object being requested and discards the response type of the object to reach the web page requestor subsystem.

9. The system (10) as claimed in claim 1, wherein the proxy subsystem (20) is configured to capture one or more errors, one or more tag execution events and track the at least one webpage (30).

10. A method (100) comprising:
receiving, by a proxy subsystem, a request from a web page requestor subsystem to fetch the plurality of web analytics tags of at least one webpage of a website; (110)
analysing, by an analysis subsystem, the plurality of web analytics tags based on a set of custom rules, (120) wherein analysis of the plurality of web analytics tags based on the set of custom rules comprises:
analysing, by a first rule, a type of object being requested by the web page requestor subsystem; (130)
analysing, by a second rule, a response type for the type of the object being requested; (140)
analysing, by a third rule, a part of the request with the response type of the object corresponding to the request received from the web page requestor subsystem; (150) and
validating, by a validation subsystem, successful execution of the plurality of web analytics tags. (160)
